(19) United States
(12) Patent Application Publication
(10) Pub. No.: US 2012/0076207 A1
(43) Pub. Date: Mar. 29, 2012

(54) MULTIPLE-CANDIDATE MOTION ESTIMATION WITH ADVANCED SPATIAL FILTERING OF DIFFERENTIAL MOTION VECTORS

(75) Inventors: Michael L. Schmit, Cupertino, CA (US); Vicky W. Tsang, Belmont, CA (US)

(73) Assignee: ADVANCED MICRO DEVICES, INC., Sunnyvale, CA (US)

(21) Appl. No.: 13/310,870

(22) Filed: Dec. 5, 2011

Related U.S. Application Data
(63) Continuation-in-part of application No. 12/347,932, filed on Dec. 31, 2008.

(51) Int. Cl. H04N 7/26

(52) U.S. Cl. 375/240.16; 375/E07.125

(57) ABSTRACT

A system and method of performing motion estimation in a video encoder is enclosed. The system and method include calculating one or more candidate motion vectors for each macroblock of a video image to form a list of candidate motion vectors, calculating a second one or more candidate motion vectors using a sub-region of at least one macroblock of the video image to include in the list of candidate motion vectors, and comparing the calculated candidate motion vectors of a first macroblock with the calculated candidate motion vectors of at least one sub-region of the first macroblock to provide the estimated contribution to the candidate motion vector of the macroblock. The calculating a second one or more candidate motion vectors using a sub-region of at least one macroblock may include using an approximation different from the calculating one or more candidate motion vectors for each macroblock.

### CROSS REFERENCE TO RELATED APPLICATION(S)

This application is a Continuation-in-Part of U.S. patent application Ser. No. 12/347,932, filed Dec. 31, 2008, which is incorporated by reference as if fully set forth.

### FIELD OF INVENTION

The disclosed embodiments relate generally to video compression technology, and more specifically to methods and systems for motion estimation and compensation using parallel processing systems.

### BACKGROUND

To reduce the amount of data transmitted in video systems, the video data is often compressed through a coding scheme. A video codec is a device or firmware/software program that enables video compression and/or decompression for digital video. In areas of video with motion, a number of pixels change from one frame to the next, and the video compression scheme must send more data to keep up with the larger number of pixels that are changing. In extreme cases of high-frequency detail changes, the video quality may decrease. In order to maintain video quality, yet reduce the amount of data that is transmitted, various different compression techniques have been developed. For example, MPEG-based video compression typically operates on square-shaped groups of neighboring pixels, called macroblocks. These blocks of pixels are compared from one frame to the next and the video compression codec sends only the differences within those blocks. Areas of video that have no motion thus require very little transmitted data.

Prediction techniques are also used in video compression systems to enable efficient encoding. The temporal prediction technique used in MPEG video is based on motion estimation. Motion estimation is based on the premise that, in most cases, consecutive video frames will be similar except for changes caused by objects moving within the frames. A motion vector is the key element in the motion estimation process. A motion vector is a two-dimensional vector used for inter prediction that provides an offset from the coordinates in the decoded picture to the coordinates in another picture, called the reference picture. It is used to represent a macroblock in a picture based on the position of this macroblock (or a similar one) in the reference picture. In general, motion estimation is the process of determining the motion vectors that describe the transformation from one two-dimensional image to another image, usually from adjacent frames in a video sequence. Motion vectors may relate to the whole image (global motion estimation) or specific parts, such as rectangular blocks, arbitrary shaped patches or even individual pixels. The motion vectors may be represented by a translational model or other models that can approximate the motion of a real video camera.

Applying the motion vectors to an image to synthesize the transformation to the next image is called motion compensation. The combination of motion estimation and motion compensation is a key part of video compression method used by the MPEG 1, 2 and 4 standards, as well as many other video codecs.

As stated above, the design of the video codecs is generally based on the statistical fact that most pixels in a sequence of video frames do not change by a significant amount; or when they do change they are still similar to their neighbor pixels either spatially or temporally. The use of motion vectors takes advantage of temporally similarity (one block of pixels remains the same from frame-to-frame); and differentially encoding the motion vectors takes advantage of spatial similarity (one block of pixels in a frame has the same motion as its neighbors). Codecs such as MPEG-2 and H.264 take advantage of the spatial similarity of motion vectors by utilizing differential encoding. FIG. 1 illustrates the concept of spatial filtering performed on neighboring macroblocks in accordance with present, known methods. In FIG. 1, each block 102 represents a macroblock of 16×16 pixels organized into a number of rows. During processing, neighboring blocks are compared with one another in a pair-wise manner, and at least two passes are required to compare each block with its neighboring block or blocks. Each block is compared with each of its two neighbors. Thus, for macroblock 2, a first comparison is performed with macroblock 1 and a second comparison is performed with macroblock 3, as shown by the arrows in FIG. 1. Processing of the overall set of macroblocks in the image, according to known spatial filtering schemes proceeds on odd-even pairs, then even-odd pairs. Thus, for the example frame structure of FIG. 1, processing proceeds relative to the left edge of the picture frame blocks, as follows:

First Pass: 1-2, 3-4, 5-6, 7-8 . . . 46-47, 48-49, 50-51, 52-53 . . . 91-92, 93-94, 95-96, 97-98, . . . .

Second Pass: 2-3, 4-5, 6-7 . . . 47-48, 49-50, 51-52 . . . 92-93, 94-95, 96-97 . . . .

This present spatial filtering method in motion detection systems performs two or more consecutive passes in series, thus consuming extra processing overhead for each pass.

What is desired, therefore, is a motion estimation system that better utilizes the parallel processing capabilities of present graphics processing units in order to provide higher quality video and lower bitrates with reduced processing overhead.

### SUMMARY OF EMBODIMENTS

Embodiments include a motion estimation method performed in a parallel processing system that determines a list of several candidate motion vectors for a macroblock of a video image and retains them through multiple computation passes. All candidate motion vectors are used as potential neighboring predictors, so that the best combination of differential vectors rises to the top of the candidate list. Numerous combinations of differential motion vectors are considered during the process that compares motion vectors among up to eight neighboring macroblocks, instead of simply between pairs of macroblocks. The motion estimation system is configured to use a large number of compute engines, such as on a highly parallel graphic processing unit (GPU) platform. This is achieved by having no dependencies between macroblocks except with one synchronization point per pass. This allows the number of calculations per pass to be very large.

A system and method of performing motion estimation in a video encoder is enclosed. The system and method may include calculating one or more candidate motion vectors for each macroblock of a video image to form a list of candidate motion vectors, calculating a second one or more candidate motion vectors using a sub-region of at least one macroblock of the video image to include in the list of candidate motion vectors, and comparing the calculated candidate motion vectors of a first macroblock with the calculated candidate motion vectors of at least one sub-region of the first macroblock to provide the estimated contribution to the candidate motion vector of the macroblock. Calculating a second one or more candidate motion vectors using a sub-region of at least one macroblock may include using an approximation different from the calculating one or more candidate motion vectors for each macroblock.

A data buffer structure for enhancing a method of calculation using multiple sorting passes is also disclosed. The data buffer structure may include an array of buffers including a buffer 0 and a plurality of other buffers configured to store at least one implied value and an implied candidate position. Buffer 0 is configured to maintain a final result of the method of calculation after each sorting pass. The data buffer structure may include a misc-bits field for storing information utilized with a cost value sorting procedure. The data buffer structure may include a plurality of convergence and stability bits, such as for providing very unstable, unstable, stable, or highly stable modes. A state machine that increments a state every time a sort results in a result that was previously achieved, and decrements the state every time the sort result is not sorted to the top of a list is also disclosed.

### BRIEF DESCRIPTION OF THE DRAWINGS

Understanding of the present invention will be facilitated by consideration of the following detailed description of preferred embodiments taken in conjunction with the accompanying drawings, in which like numerals refer to like parts.

FIG. 1 illustrates a spatial filtering method performed on neighboring macroblocks in accordance with present, known techniques.

FIG. 2 is a block diagram of an encoder pipeline that implements embodiments of a motion estimation component, under an embodiment.

FIG. 3 illustrates an example set of macroblocks for an image or image fragment on which a motion estimation process is performed, under an embodiment.

FIG. 4 is a flowchart illustrating the main steps of determining a motion vector for a macroblock, under an embodiment.

FIG. 5 illustrates a method of calculating candidate motion vectors for each macroblock, under an embodiment.

FIG. 6 is a flowchart that illustrates a method of comparing candidate motion vectors to determine a best motion vector for a macroblock, under an embodiment.

FIG. 7 is a flowchart that illustrates a method of fine tuning differentials between motion vectors, under an embodiment.

FIG. 8 is a flowchart that illustrates a method of calculating candidate motion vectors using different candidates from a given region.

FIG. 9 illustrates an example set of different candidates from a given region on which a motion estimation process is performed.

FIG. 10 illustrates a stability/convergence state machine.

### DETAILED DESCRIPTION OF THE PREFERRED EMBODIMENTS

Embodiments of the invention as described herein provide a solution to the problems of conventional methods as stated above. In the following description, various examples are given for illustration, but none are intended to be limiting. Embodiments include a motion estimation component that is incorporated in a software or hardware encoder pipeline and allows the encoder to maintain the same or similar relative level of video quality at a lower bitrate (higher compression ratio). The motion estimation component obtains the lower bitrate while performing fewer calculations than other methods used in present known encoders.

In MPEG-based video compression systems, the minimum independently encoded rectangle on the frame is called macroblock, and has a size of 16×16 pixels, with each frame having a periodicity of 1/30 of a second. Certain systems perform compression by statistically analyzing the whole frame of 16×16 pixels to determine a level of activity ranging from none or very little activity being discarded (this is true for spatial activity only). For full motion video, this type of analysis is usually adequate to perform compression in which perceptually insignificant information is discarded and human perception is relied upon to fill-in the missing data so that the compressed image appears identical to the original uncompressed version. In general, every codec can give a varying degree of quality for a given set of frames within a video sequence. Typically, the quality is controlled through a bitrate control mechanism (bitrate allocation) that sets the bitrate and quality on a per-frame basis.

A general design goal is to use the lowest bitrate possible to encode digital video data. The H.264 standard for video compression was developed to provide good video quality at substantially lower bit rates than previous standards (e.g., half or less the bit rate of MPEG-2, H.263, or MPEG-4 Part 2), without overly increasing the complexity of design. The H.264 (also known as MPEG-4 Part 10 or MPEG-4 AVC) specification has become the standard for video compression, and contains a number of features that allow it to compress video much more effectively than older standards and to provide more flexibility for application to a wide variety of network environments. These features include variable block-size motion compensation (motion estimation) with block sizes as large as 16×16 and as small as 4×4, enabling precise segmentation of moving regions, and the ability to use multiple motion vectors per macroblock.

For purposes of this description, “H.264” refers to the standard for video compression that is also known as MPEG-4 Part 10, or MPEG-4 AVC (Advanced Video Coding). H.264 is one of the block-oriented motion-estimation-based codecs developed by the ITU-T Video Coding Experts Group (VCEG) together with the ISO/IEC Moving Picture Experts Group (MPEG).

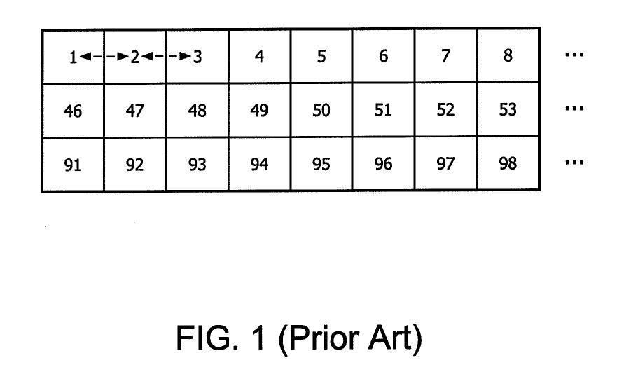

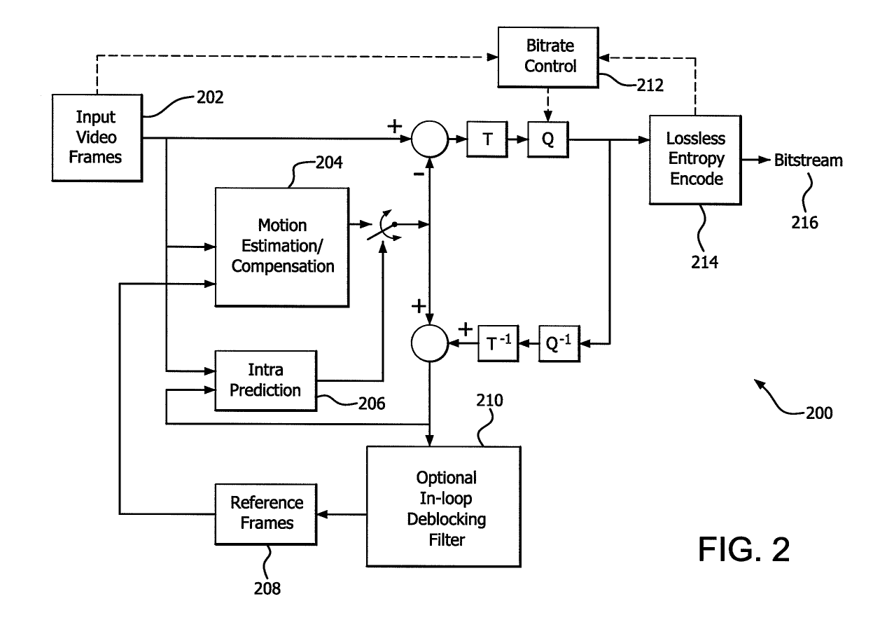

Many current video codecs, such as H.264 codecs utilize a form of differential encoding to take advantage of the temporal and spatial similarity between neighboring macroblocks in an image. Embodiments of an encoding system provide an improvement over present spatial filtering techniques that are performed on neighboring macroblocks, such as shown in FIG. 1. FIG. 2 is a block diagram of an encoder pipeline that implements embodiments of a motion estimation component, under an embodiment. The motion estimation component is configured to maximize video quality by finding the best motion vector for each macroblock by performing iterative comparison and scoring steps relative to multiple neighbor macroblocks through the use of multiple processing engines in a highly parallel computing environment.

System 200 of FIG. 2 is an embodiment of an encoder pipeline that receives input video frames 202 and produces an encoded video bitstream 216. The input video frames 202 are input to a motion estimation component 204 and in intra-prediction unit 206. The output of these components are then combined with the original input video frames through a transform process (T), such as a forward discrete cosine transform (fDCT) module, and a quantization process (Q). The quantized data is then processed through an inverse quantization process (Q-1) and an inverse transform process (T-1), such as iDCT. The inversely transformed data is then combined with the motion estimation output for the intra-prediction unit 206 and an optional in-loop deblocking filter 210 to generate reference frames 208. A bitrate control unit 212 provides control over the quantization (Q) process, which also takes input from a lossless entropy decode module 214 to produce the output bitstream 216. The bitrate control unit 212 receives uncompressed video data 202 from a source and produces a compressed video signal 216 in accordance with an encoding method, such as standard H.264 encoding. A rate controller component dynamically adjusts encoder parameters to achieve a target bitrate specified by a bitrate parameter. The rate controller allocates a budget of bits to each region, individual picture, group of pictures, and/or sub-picture in a video sequence.

In one embodiment, the motion estimation component 204 implements a method that performs filtering and analysis of proposed neighboring motion vectors in a manner that does not require any dependencies between neighboring calculations within a large processing step or pass. This facilitates the use of separate computing engines per macroblock. Such computing engines could be an individual shader processor in a graphics processing unit (GPU) or a dedicated hardware circuit for motion estimation. Thus, the system of FIG. 2 can be implemented in a parallel processor computing environment, such as a system that includes multiple central processing unit (CPU) cores, multiple GPU cores, or a hybrid multi-core CPU/GPU system. Embodiments of the motion estimation component can also be used in a GPU shader system. In general, a shader is a set of software instructions, which is used by the graphic resources primarily to perform rendering effects. Shaders are written to apply transformations to a large set of elements at a time, such as to each pixel in an area of the screen, or for every vertex of a model. Shaders are thus particularly well suited to parallel processing, such as in present multi-core GPU systems.

The motion estimation method performed by component 204 determines a list of several candidate motion vectors and retains them through multiple computation passes. This method prevents a single best cost score in the initial pass from prematurely dominating the results for its macroblock. All candidate motion vectors are used as potential neighboring predictors, so that the best combination of differential vectors rises to the top of the candidate list. Numerous combinations of differential motion vectors are considered during the process that compares motion vectors among up to eight neighboring macroblocks, as opposed to between pairs of macroblocks. The motion estimation system is configured to use a large number of compute engines, such as on a highly parallel GPU platform. This is achieved by having no dependencies between macroblocks except with one synchronization point per pass. This allows the number of calculations per pass to be very large.

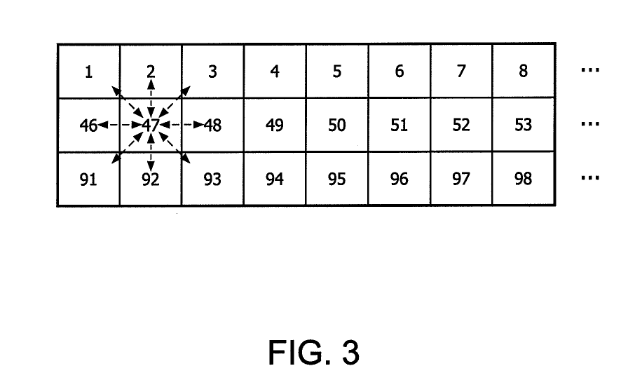

In one embodiment, a multi-pass process using multiple parallel processors is executed on a set of macroblocks to determine the best motion vector. Instead of comparing individual pairs of macroblocks, as shown in FIG. 1, the method compares differentials to a number of possible close neighbors of a single macroblock, such as up to eight neighbors. FIG. 3 illustrates an example set of macroblocks for an image or image fragment on which a motion estimation process is performed, under an embodiment. The image fragment of FIG. 3 includes a number of macroblocks, which could be 16×16 blocks, or smaller. For the video image pattern of FIG. 3, most macroblocks have up to eight neighbors. Thus, for the example macroblock 47, differential comparisons are performed for the eight neighbors 1, 2, 3, 46, 48, 91, 92, and 93, as shown by arrows of FIG. 3.

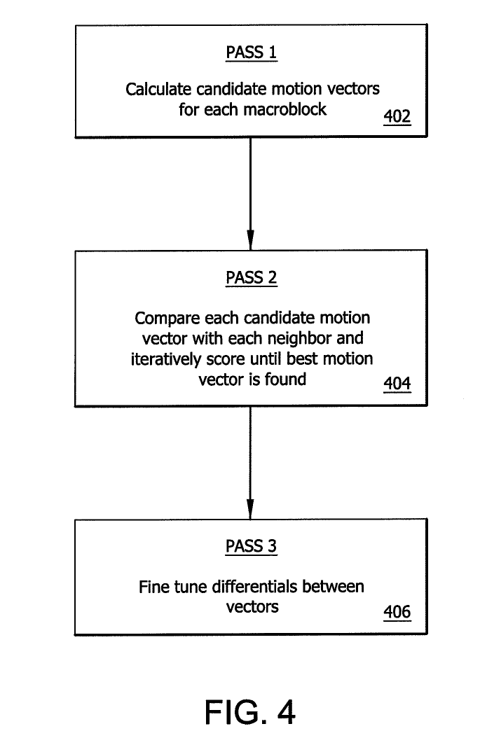

FIG. 4 is a flowchart illustrating the main steps of determining a motion vector for a macroblock, under an embodiment. In one embodiment, the process proceeds in three passes, in which the first pass generally determines and sorts candidate motion vectors for each macroblock of a number of macroblocks of the video image, block 402. The second pass compares each candidate motion vector with neighboring candidate motion vectors and performs an iterative scoring process until the best motion vector is determined, block 404. The third pass is an optional step that comprises performing a spatial filtering step to fine tune any differentials between macroblock motion vectors, block 406. The detailed processing steps for each of the passes are explained in the flowcharts that follow.

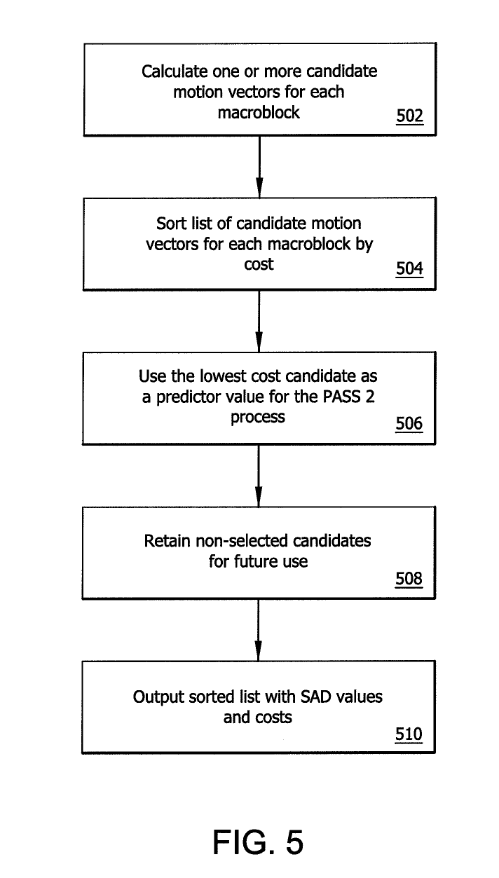

FIG. 5 illustrates a method of calculating candidate motion vectors for each macroblock, under an embodiment. In block 502, one or more candidate motion vectors (CMVs) for each macroblock are calculated. The candidate motion vectors can be calculated using one of any number of known conventional methods. An example of this process will be provided using four candidates, and a minimum sum of absolute differences (SAD) process, although any similar metric could be used.

The SAD metric for block-matching in the motion estimation process works by taking the absolute value of the difference between each pixel in the original block and the corresponding pixel in the block being used for comparison. These differences are summed to create a simple metric of block similarity, the L1 norm of the difference image. In alternative embodiments, other metrics can be used, such as the sum of the square of absolute differences (SSAD). Another possible metric is the sum of absolute transformed differences (SATD), which works by taking a frequency transform, usually a Hadamard transform (SAHD), of the differences between the pixels in the original block and the corresponding pixels in the block being used for comparison. The transform itself is often of a small block rather than the entire macroblock. For example, a series of 4×4 blocks may be transformed rather than the full 16×16 transform. In general, SATD is slower than SAD due to its increased complexity, but has the benefit of being able to more accurately predict quality from both the standpoint of objective and subjective metrics.

In one embodiment, a hierarchical searching method is used to calculate the CMVs for each macroblock. A box area is defined around the block and is then divided into multiple regions. The process then searches each region as if it is the region of interest. In one example, four regions are defined and four CMV values are determined. These values are denoted CMV1, CMV2, CMV3, and CMV4. In this method, the area is downsampled by a defined ratio, such as one-quarter in each dimension. Thus, if the size of the region is 100×100, the downsampling operation yields a search of a 4×4 block within region of 25×25, instead of a search of a 16×16 block within a region of 100×100.

Each macroblock will have a list of CMVs, such as CMV1-4. The list of candidate motion vectors for each macroblock is then sorted by cost, block 504. The minimum cost generally yields the best candidate. In one embodiment the cost is calculated by the following equation:

Cost=SAD+λ(dMV_{X} and dMV_{Y})

In the above equation, dMV_{X} and dMV_{Y} are the differential motion vectors in X and Y respectively. Collectively dMV_{X} and dMV_{Y} are referred to herein as the differential motion vector (dMV), with the differential from a predicted motion vector. The predicted motion vector may be 0, 0 or some other motion vector. The lambda (λ) factor is a normalization factor whose value can be selected depending on the requirements of the system and may be varied based on the target quality and target bitrate.

As shown in block 506 of FIG. 5, the lowest cost (best) candidate is used as a predictor for the next pass. That is, the lowest cost CMV candidate is used in the future DMV calculations. The non-chosen candidates are retained for future use, block 508, and the output of the first pass of the process is the sorted list, with SADs and cost, block 510.

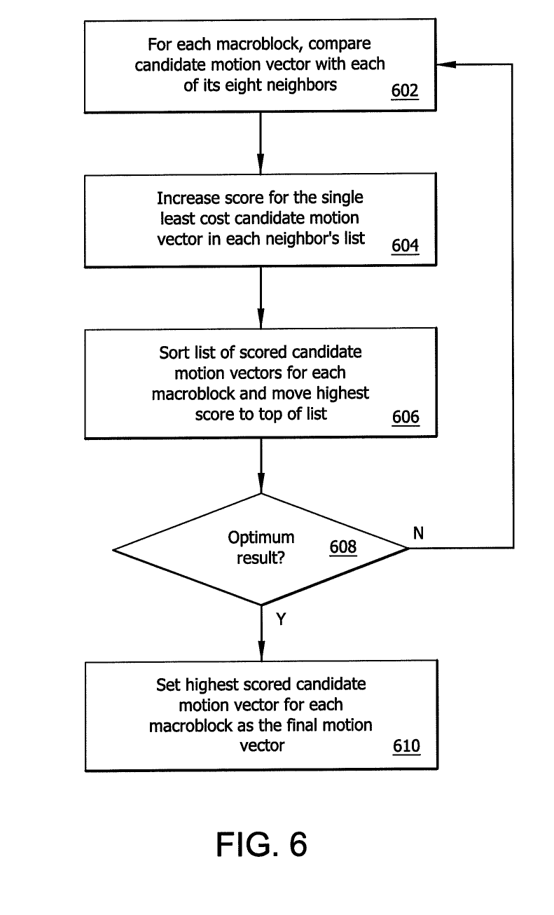

FIG. 6 is a flowchart that illustrates a method of comparing candidate motion vectors to determine a best motion vector for a macroblock, under an embodiment. As shown in block 602, the process starts by performing a comparison of each candidate motion vector with each of its eight neighbor's CMVs, one by one, as shown in FIG. 3 in which, for example, the single macroblock number 47 is compared with each of its eight neighbors: 1, 2, 3, 46, 48, 91, 92 and 93. Around the edges some macroblocks will have fewer neighbors, thus the comparison step for these macroblocks may involve fewer than eight macroblocks. The comparison step checks the entire list of candidate motion vectors in each neighbor macroblock's sorted list and calculates its cost (such as by using the above cost equation. The comparison step determines the degree of similarity between the CMVs. If the CMV values are the same, then no bits are changed between the compared macroblocks. The candidate motion vectors are selected from the group of differential motion vectors (dMV) that are the possible differentials from a block to each of the eight surrounding blocks.

In block 604, the score for the single least CMV in each neighbor's list is increased. In a simple implementation, the single least cost CMV in each neighbor's list gets a scoring value of one added to its score. In other words, the calculations for a single macroblock cause one scoring point to be added to one CMV in each of its neighbors. This may be repeated for each macroblock. All of the CMVs of each non-edge macroblock may be scored eight times, for example. Alternatively, weighted scores are added to multiple CMV's in each list.

In one embodiment, for block 604, a flag can be set (or some sharable global counter can be incremented) such that each time the highest scored CMV is changed a total number of changes can be accumulated to provide an indication of when the number of changes per pass is low; such that excessive passes are not used. Alternatively, some fixed number of passes can be used based on testing, available time, quality settings, and so on.

After all scoring is completed, the list of CMVs for each macroblock is sorted, with the highest score placed at the top of the list, block 606. Note that the highest score is different from the least cost. In general, the sorting step may change the “best” motion vector for some macroblocks. Since the best is used for the scoring calculation there may be some new best CMVs. In block 608, it is determined whether or not an optimum or acceptable result is reached. A near optimum result may be acceptable after a certain number of flip-flops of some number of CMV in all the sum of macroblocks when the threshold of changes is low. In one embodiment, this defines a relative equilibrium point at which further iterations do not add a significant improvement. An incremental improvement value may be defined to determine such an optimum result. If the optimum result is not reached, the process repeats from block 602, until relative equilibrium is reached with the optimum or near optimum result. The highest scored and sorted CMV is then set as the final resultant motion vector for each macroblock, block 610.

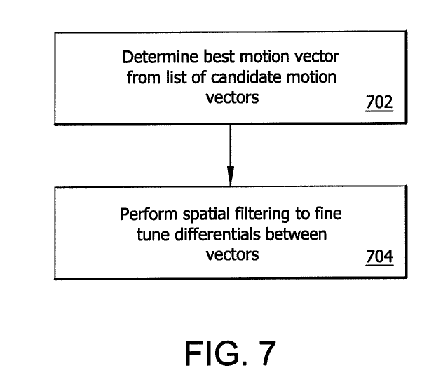

FIG. 7 is a flowchart that illustrates a method of fine tuning differentials between motion vectors, under an embodiment. As shown in block 702, the best motion vector is determined from the list of candidate motion vectors. This best motion vector generally represents motion vector that all the neighbors might find beneficial, in terms of being spatially alike. In block 704, the process performs a spatial filtering step (SFODMV) that fine tunes the differentials between vectors. This helps adjust for minor differentials that can be reduced to zero with some small increase in coefficient bits. This step may be considered optional depending on the quality and performance settings of the system, and in some cases, such fine tuning is unnecessary.

In general, the overall motion estimation process to calculate the best motion vector for each macroblock of a video image illustrated in FIGS. 5-7 produces a better video image with lower bitrates than conventional methods. The method includes a list of several candidate motion vectors and retains them through multiple computation passes; this prevents a single best SAD score in the initial pass from prematurely dominating the results for its macroblock. Additionally, all candidate motion vectors are used as potential neighboring predictors so that the best combination of differential vectors rises to the top of the list. Moreover, numerous combinations of differential motion vectors are attempted, but instead comparing just individual pairs of macroblocks, the process compares differentials to all eight possible close neighbors.

In an embodiment, all possible neighbors are checked even though a particular codec may not support such a neighbor as a predictor. This is done because an inverse predictor might be valid and the direction of the predictor makes very little difference in trying to determine the smallest dMV on average for the whole image.

In one embodiment, the method is implemented in a computing platform that uses a large number of compute engines, such as a highly parallel GPU platform. This enables the method to perform the relatively high number of computations required, in a reasonable amount of time. This is generally achieved by having no dependencies between macroblocks except with one synchronization point per pass. The number of calculations per pass may be large, but there are no dependencies between macroblocks.

The number of processors that are used depends on the constraints of the system and the requirements of the video stream compression application. For example, in a typical case, about 2560 threads at a time threads may be used to process 8160 macroblocks. This may be provided by a system that has 160 individual processors and is determined through the equation 160(4(N)), where 4 represents the number of threads processed at once on a processor in a group, and N(=2, 4, or 8) represents the number of groups that can be scheduled at once to overcome memory latency.

In the described motion estimation process, the filtering and analysis of the proposed neighboring motion vectors attempts to make two vectors the same, even if the “best” proposed vectors were not the same. This helps to improve video quality and/or lower the bitrate because in some percentage of cases the bits saved by making the vectors the same can be more than the bits lost by having a slightly greater residual data to compress. This type of filtering is very well suited to GPU processing where all the blocks are considered and compared in parallel in the GPU shader model of computing rather than the sequential block processing done on a CPU. However, the concept is applicable for CPUs, GPUs and dedicated hardware encoders. The specific filtering used may be selected based on the actual codec that is being used.

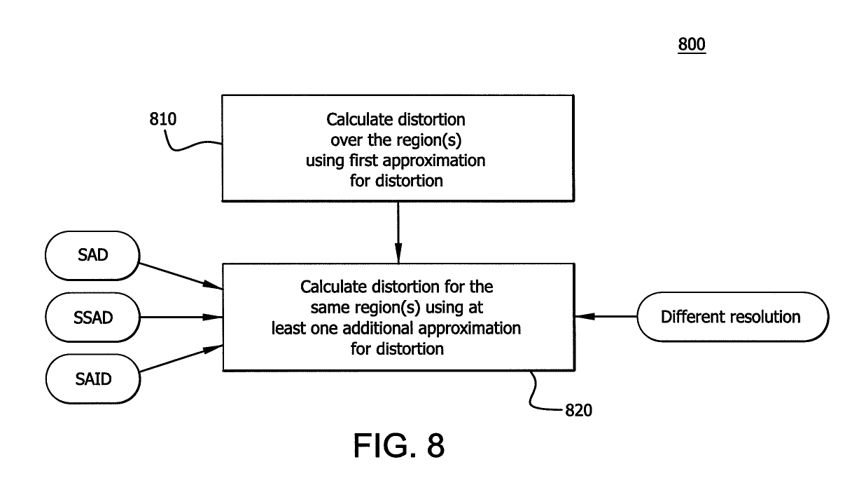

A method of calculating candidate motion vectors using different candidates from a given region is illustrated in FIG. 8. The method for calculating candidate motion vectors using different candidates from the same region may provide the algorithm the ability to estimate contribution to the overall quality of candidate motion vectors. This estimated contribution may be measured/achieved by using various measurements of costs (in bits) for a given distortion matter.

As discussed above with respect to at least FIGS. 4-7, each single search area may be divided into multiple mutually exclusive spatial regions and a plurality of these exclusive spatial regions may be analyzed. Additionally, distortion calculations may be duplicated over a given region or regions, or over sub-regions within a given region, using at least one different approximation for the distortion in the duplicative calculation. The duplicative calculation may include one, two or a series of calculations on the same or different regions. That is, one sub-region may be identified and a series of calculation may be performed on this sub-region with each calculation having a different approximation, and/or several different sub-regions may be identified and a calculation performed on each sub-region using an approximation. Also, combinations of different regions, sub-regions and approximations may be used in any combination. These duplicative calculations may be performed using a second approximation for all calculations, using a second and/or third approximation, or using a myriad of different approximations, as necessary or desired.

Referring now specifically to FIG. 8 and a method 800 shown therein. FIG. 8 is a flowchart that illustrates a method of calculating candidate motion vectors using different candidates from a given region. Method 800 may include a step of calculating the distortion over a region or regions using a first approximation for the distortion in step 810. Subsequently or simultaneously, method 800 may include calculating the distortion over the same region or regions using at least one additional approximation for the distortion in step 820. As discussed, the approximation for the distortion may include SAD (sum of absolute differences), SSAD (sum of squares of absolute differences), and SATD (sum of transformed differences). Additionally, different approximations for the distortion may include any of the algorithms discussed herein operating with a different resolution, such as a 16×16, 8×8 (2×2 downscale), and 4×4 (4×4 downscale), for example.

This additional calculation for distortion may be performed on one processor while another processor calculates a larger area search as described above. For example, a low compute algorithm may search over a large area of several regions while a smaller area near the same prediction or another prediction point may be searched with a higher precision and/or using a more computation-intensive algorithm.

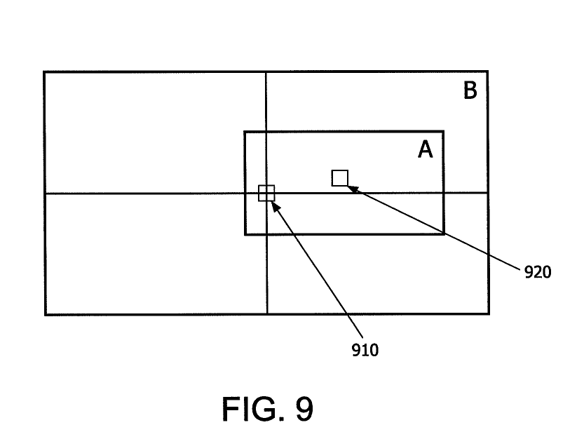

An example of the operation of method 800 is shown in FIG. 9. Shown in FIG. 9 is region A and region B. Region B is divided into 4 sub regions. Analysis of each of the sub regions of region B may result in 4 motion vector candidates and a prediction B 910, which is shown in FIG. 9. Analysis of region A may result in an additional motion factor candidate and a prediction A 920, which is shown in FIG. 9. It is possible for the best candidate from region A to be close to or identical to one of the B regions. As set forth in method 800, analysis of region A may be performed using at least one additional approximation for distortion.

In implementing the present calculations various data buffer structures may be used. For example, a non-obvious data buffer structure may be used for the collection and storage of the different candidates. This structure may improve the performance on highly data parallel architectures, such as GPUs employing a parallel array of shaders, as well as implementations using multiple GPUs or heterogeneous computing environment, such as GPUs plus CPUs.

Generally, a data buffer structure for partitioning a large area into multiple regions may include an array of results such that the several results are sequentially arranged in memory. Such a data buffer structure may be sorted by accessing a small portion of the memory. For example, for a search with 1000 macroblocks and 4 candidates per block, the data buffer structure may be organized using four 16-bit unsigned integers as:

MB000, result1: MVx, MVy, cost, misc_bits
MB000, result2: MVx, MVy, cost, misc_bits
MB000, result3: MVx, MVy, cost, misc_bits
MB000, result4: MVx, MVy, cost, misc_bits
MB001, result1: MVx, MVy, cost, misc_bits
MB001, result2: MVx, MVy, cost, misc_bits
MB001, result3: MVx, MVy, cost, misc_bits
MB001, result4: MVx, MVy, cost, misc_bits
. . .
MB999, result1: MVx, MVy, cost, misc_bits
MB999, result2: MVx, MVy, cost, misc_bits
MB999, result3: MVx, MVy, cost, misc_bits
MB999, result4: MVx, MVy, cost, misc_bits,

where MBxxx=implied macroblock value and resultx=implied multiple candidate position.

Alternatively, a data buffer structure utilizing an array of buffers may be used. This array of buffers may be organized as follows:

Buffer_0:

MB000, result1: MVx, MVy, cost, misc-bits
MB001, result1: MVx, MVy, cost, misc-bits
. . .
MB999, result1: MVx, MVy, cost, misc-bits

Buffer_1:

MB000, result2: MVx, MVy, cost, misc-bits
MB001, result2: MVx, MVy, cost, misc-bits
. . .
MB999, result2: MVx, MVy, cost, misc-bits

Buffer_2:

MB000, result3: MVx, MVy, cost, misc-bits
MB001, result3: MVx, MVy, cost, misc-bits
. . .
MB999, result3: MVx, MVy, cost, misc-bits

Buffer_3:

MB000, result4: MVx, MVy, cost, misc-bits
MB001, result4: MVx, MVy, cost, misc-bits
. . .
MB999, result4: MVx, MVy, cost, misc-bits

Using the array of buffers can enhance any method of calculation, such as those provided herein, and may be beneficial to a method using parallel GPUs. The array of buffers can operate by maintaining the final result after each sorting pass in buffer 0. Maintaining the final result in buffer 0 can be independent of how many buffers (regions or algorithms) are used. Further, the final result in buffer 0 may be maintained at all points during the processing, even including when a timeout on algorithm elapsed time occurs, for example. In addition, using the array of buffers architecture allows for additional algorithms and may provide for any needed additional buffers without impacting the existing code and configuration, thereby providing for a scalable architecture. Within the array of buffers, algorithm components may be focused on a specific task. For example, within a given buffer or group of buffers a given approximation may be performed. That is, search algorithms can operate with a single buffer to store the result of that calculation.

The cost bits may be tracked in each buffer. When different search algorithms are used, the “cost” field for the result may be normalized to an equivalent metric. For example, if SAD is used on a 4×4 downsampled block in one region and a SAD is 8×8 on a 2×2 downsampled block in another region, then the 4×4 SAD values may be multiplied by 4 to normalize the cost comparison as between these two methodologies.

The misc_bits field may be used to store information which may be utilized with the cost value of a sorting procedure. For example, the misc-bits field may be used to indicate how the distortion approximation is calculated, the confidence level of the computation, stability measure of each candidate during the multipass scoring/sorting procedure, and/or bugging and performance monitoring flags.

In addition, the data buffer structure may contain several bits that indicate the convergence and/or stability or measures thereof. For example, when using multiple passes that compare to neighbors, a two bit field may be used with:
0:00 very unstable
1:01 unstable
2:10 stable
3:11 highly stable

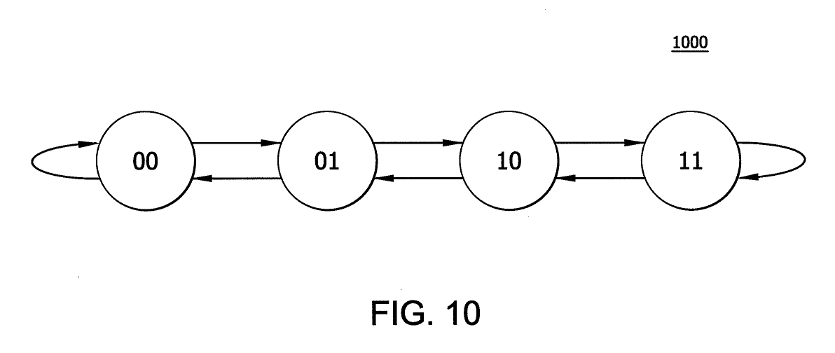

A stability/convergence state machine 1000 is shown in FIG. 10. State machine 1000 may be based on the two bit field described above. Each of the states 0-3 may included in the state machine as shown in FIG. 10. Each time a sort results in the same result, the state may be incremented. Each time a sort result is not sorted to the top of the list, the state may be decremented. At the end of each scoring/sorting pass, a count of the number of values of each stability measure (0, 1, 2, 3) of the best results buffer (buffer 0) may be computed and compared to previous passes. As the number of candidates with values of 3, or the sum of 2 and 3, or another metric of state machine 1000 reaches or nears a peak, the algorithm may be determined to be converged to a near optimal conclusion. Such a state machine may enable a computation in real-time to determine when the algorithm should end. Similarly, the computation may be performed during testing to pre-decide the number of passes that is optimal or maximum. The computation may provide the real-time counts after some number of predetermined passes and/or only on some frames to update the optimal or maximum pass count.

In general, embodiments described herein are directed to a method of performing motion estimation in a video encoder, comprising: calculating one or more candidate motion vectors for each macroblock of a video image to form a list of candidate motion vectors, calculating a cost for each candidate motion vector, sorting the list of candidate motion vectors by cost from lowest cost to highest cost, comparing the calculated candidate motion vectors of a first macroblock with the calculated candidate motion vectors of a plurality of neighbor macroblocks using the lowest cost candidate motion vector as the basis of the cost calculation, assigning a base score to each candidate motion vector for each macroblock with the lowest cost candidate motion vector for each macroblock receiving an increased base score, and increasing the base score or increased base score of a respective candidate motion vector by a point depending on its similarity with a candidate motion vector in a neighbor macroblock. Through an iterative process, the method resorts the list of candidate motion vectors based on score from lowest score to highest score to create a new list of candidate motion vectors, re-compares each candidate motion vector of the new list of candidate motion vectors with the calculated candidate motion vectors of the plurality of neighbor macroblocks, and re-scores the candidate motion vectors to determine the highest scoring candidate motion vector, and repeats these steps until the number of changes of the highest scoring candidate vector is below a defined minimum threshold. The method may also perform a spatial filtering step on the motion vector for each macroblock to adjust for minor differences between the motion vectors for the macroblocks. The method may be executed in a multi-processor computing environment in which a dedicated processing engine of a multi-processor system performs the step of calculating the one or more candidate motion vectors for a respective macroblock.

Embodiments of the motion estimation process described herein can be applied to standard predictive MPEG schemes, such as for the circuit of FIG. 2, in which an intra-prediction block 206 and associated circuitry is included. In processing a video stream, the MPEG encoder produces three types of coded frames. The first type of frame is called an “I” frame or intra-coded frame. This is the simplest type of frame and is a coded representation of a still image. In general, no motion estimation processing is performed on I-frames; their purpose is to provide the decoder a starting point for decoding the next set of frames. The next type of frame is called a “P” frame or predicted frame. Upon decoding, P-frames are created from information contained within the previous P-frames or I-frames. The third type of frame, and the most common type, is the “B” frame or bi-directional frame. B-frames are both forward and backward predicted and are constructed from the last and the next P or I-frame. Both P-frames and B-frames are inter-coded frames. A codec encoder may encode a stream as the following sequence: IBBP . . . In real-time digital video transmission, B-frames are often not used. In this case, the sequence may just consist of I-frames followed by a number of P-frames.

Although embodiments have been described in relation to the H.264 standard, it should be noted that other similar standards may also be used as the basis for encoder circuit of FIG. 2. Embodiments can also be directed to variable block-size motion systems with block sizes as large as 16×16 and as small as 4×4, or intermediate sizes, such as, 16×8, 8×16, 8×8, 8×4, and 4×8.

Embodiments can be used in transcoding systems. Transcoding is the direct digital-to-digital conversion of one digitally encoded format to another format. Transcoding can be found in many areas of content adaptation and is often used to convert incompatible or obsolete data into a more suitable format. It is also used to archive or distribute content on different types of digital media for use in different playback devices, such as converting songs from CD format to MP3 format for playback on computers and MP3 players and/or in converting video from a DV or DVC format camcorder to an MPEG-2 DVD, for example. Transcoding is also commonly used in the area of mobile phone content adaptation. In this case, transcoding is necessary due to the diversity of mobile devices and their capabilities. This diversity requires an intermediate state of content adaptation in order to make sure that the source content will adequately play back on the target device.

Although embodiments of the motion estimation system and process are directed to GPU components, such as GPU shaders, the method could be used on any computing device that implements some form of parallel computing. Furthermore, although embodiments have been described with reference to graphics systems comprising GPU devices or visual processing units (VPU), which are dedicated or integrated graphics rendering devices for a processing system, it should be noted that such embodiments can also be used for many other types of video production engines that are used in parallel. Such video production engines may be implemented in the form of discrete video generators, such as digital projectors, or they may be electronic circuitry provided in the form of separate IC (integrated circuit) devices or as add-on cards for video-based computer systems. In one embodiment, the system including the GPU control system comprises a computing device that is selected from the group consisting of: a personal computer, a workstation, a handheld computing device, a digital television, a media playback device, smart communication device, and a game console, or any other similar processing device.

The systems and/or components described herein may be implemented as one or more electronic circuits. Such circuits described herein can be implemented through the control of manufacturing processes and maskworks, which would be then used to manufacture the relevant circuitry. Such manufacturing process control and maskwork generation known to those of ordinary skill in the art include the storage of computer instructions on computer readable media including, for example, Verilog, VHDL or instructions in other hardware description languages.

Aspects of the system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects of the video stream migration system may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on). Additionally, embodiments may comprise applications which enable video encoding (such as video editing software, content creation software and the like). Such applications may include instructions which program general and/or special purpose processors (such as CPUs and/or GPUs or combinations thereof) to implement aspects of the invention described herein. Such applications may generate encoded video data which were produced in manners described herein.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the motion estimation method and system is not intended to be exhaustive or to limit the embodiments to the precise form or instructions disclosed. While specific embodiments of, and examples for, processes in graphic processing units or ASICs are described herein for illustrative purposes, various equivalent modifications are possible within the scope of the disclosed methods and structures, as those skilled in the relevant art will recognize.

The elements and acts of the various embodiments described above can be combined to provide further embodiments. These and other changes can be made to the disclosed system in light of the above detailed description.

In general, in the following claims, the terms used should not be construed to limit the disclosed method to the specific embodiments disclosed in the specification and the claims, but should be construed to include all operations or processes that operate under the claims. Accordingly, the disclosed structures and methods are not limited by the disclosure, but instead the scope of the recited method is to be determined entirely by the claims.

While certain aspects of the disclosed embodiments are presented below in certain claim forms, the inventors contemplate the various aspects of the methodology in any number of claim forms. For example, while only one aspect may be recited as embodied in machine-readable medium, other aspects may likewise be embodied in machine-readable medium. Accordingly, the inventors reserve the right to add additional claims after filing the application to pursue such additional claim forms for other aspects.

What is claimed is:

1. A method of performing motion estimation with respect to images in video frames comprising:
calculating a first candidate motion vector for each macroblock of an image in a video frame to form a list of candidate motion vectors;
calculating a second candidate motion vector using a sub-region of at least one macroblock of the image to include in the list of candidate motion vectors; and
comparing the calculated candidate motion vectors of a first macroblock with the calculated candidate motion vectors of at least one sub-region of the first macroblock to provide the estimated contribution to the candidate motion vector of the macroblock.

2. The method of claim 1 further comprising:
assigning a base score to each candidate motion vector for each macroblock with the lowest cost candidate motion vector for each macroblock receiving an increased base score; and
increasing the base score or increased base score of a respective candidate motion vector by a point depending on its similarity with a candidate motion vector in a sub-region of the macroblock.

3. The method of claim 2 further comprising:
sorting the list of candidate motion vectors based on score from highest score to lowest score to create a new list of candidate motion vectors;
re-comparing each candidate motion vector of the new list of candidate motion vectors with the calculated candidate motion vectors of the plurality of neighbor macroblocks; and
scoring the candidate motion vectors to determine the highest scoring candidate motion vector.

4. The method of claim 3, wherein the steps of sorting, re-comparing, and scoring are iteratively repeated until a number of changes of the highest scoring candidate vector is below a defined minimum threshold.

5. The method of claim 4, wherein the defined minimum threshold is selected from the group consisting of: a maximum flag value, a defined number of iterations, and a maximum amount of processing time to perform the number of iterations.

6. The method of claim 5, further comprising performing a spatial filtering step on the motion vector for each macroblock to adjust for minor differences between the motion vectors for the macroblocks.

7. The method of claim 6, wherein the spatial filtering step reduces the differences between the motion vectors to zero by potentially increasing one or more coefficient bits of the motion vectors.

8. The method of claim 5, further comprising performing a spatial filtering step on the motion vector for each macroblock and on the motion vector for each sub-region to adjust for minor differences between the motion vectors for the macroblocks.

9. The method of claim 8, wherein the spatial filtering step reduces the differences between the motion vectors to zero by potentially increasing one or more coefficient bits of the motion vectors.

10. The method of claim 1, wherein the calculating a second one or more candidate motion vectors using a sub-region of at least one macroblock comprises using an approximation different from the calculating one or more candidate motion vectors for each macroblock.

11. The method of claim 10, further comprising estimating the contribution of each calculation to the candidate motion vector.

12. A method of performing motion estimation with respect to images in video frames comprising:
calculating a candidate motion vector for a macroblock of an image in a video frame;
calculating at least one additional candidate motion vector using at least one sub-region within the macroblock; and
comparing the calculated candidate motion vectors of the macroblock with the calculated at least one additional candidate motion vector to provide the estimated contribution to the overall quality of the candidate motion vectors.

13. The method of claim 12, wherein the calculating at least one additional candidate motion vector using the at least one sub-region within the macroblock comprises using an approximation different from the calculating a candidate motion vectors for the macroblock.

14. The method of claim 12, further comprising calculating a cost for each candidate motion vector.

15. The method of claim 14, wherein the cost is calculated utilizing a metric value summed with a differential motion vector multiplied by a normalization value.

16. The method of claim 15, wherein the cost is normalized to an equivalent metric.

17. The method of claim 15, wherein the metric is one of the sum of absolute differences (SAD), sum of the square of absolute differences (SSAD), or the sum of the transformed differences (SATD).

18. A data buffer structure for enhancing a method of calculation using multiple sorting passes, the data buffer structure comprising:
an array of buffers including a buffer 0 and a plurality of other buffers configured to store at least one implied value and an implied candidate position; and
the buffer 0 configured to maintain a final result of the method of calculation after each sorting pass.

19. The data buffer structure of claim 18, further comprising a misc-bits field for storing information utilized with a cost value sorting procedure.

20. The data buffer structure of claim 19, further comprising a plurality of convergence and stability bits.

21. The data buffer structure of claim 20, wherein the plurality of convergence and stability bits comprises two bits.

22. The data buffer structure of claim 21, wherein the two bits provide very unstable, unstable, stable, or highly stable modes.

23. The data buffer structure of claim 21, further comprising a state machine that increments a state every time a sort results in a result that was previously achieved, and decrements the state every time the sort result is not sorted to the top of a list.
